(19) United States
(12) Patent Application Publication
(10) Pub. No.: US 2024/0331448 A1
(43) Pub. Date: Oct. 3, 2024

(54) POSTURE RECOGNITION SYSTEM, METHOD AND ELECTRONIC DEVICE

(71) Applicant: BOE Technology Group Co., Ltd., Beijing (CN)

(72) Inventors: Ruifeng QIN, Beijing (CN); Jing YU, Beijing (CN); Peng HAN, Beijing (CN); Huidong HE, Beijing (CN); Qianwen JIANG, Beijing (CN); Weihua DU, Beijing (CN); Juanjuan SHI, Beijing (CN)

(21) Appl. No.: 18/649,574

(22) Filed: Apr. 29, 2024

Related U.S. Application Data
(63) Continuation of application No. PCT/CN2023/085679, filed on Mar. 31, 2023.

(51) Int. Cl. G06V 40/20; G06F 3/01; G06T 7/521; G06T 7/55; G06V 10/12; H04N 23/66

(52) U.S. Cl. CPC G06V 40/28; G06T 7/521; G06T 7/55; G06V 10/12; H04N 23/66; G06F 3/017; G06T 2207/10028; G06T 2207/10048; G06T 2207/30196

(57) ABSTRACT

A posture recognition system, a method and an electronic device. The system includes: N depth cameras, N processing modules and a control module; the N depth cameras capture target images from different locations, and transmit the target images captured respectively to corresponding processing modules, wherein the target images contain depth information of a target object; the N processing modules respectively determine a depth map of the target object based on the depth information contained in the target images received respectively, perform posture recognition on the target object in the target images in view of the depth map of the target object, to obtain N recognition results corresponding to the N depth cameras respectively, and send the N recognition results to the control module; and the control module combines the N recognition results, and determines a combination result as a recognition result of the target image.

### CROSS-REFERENCE TO RELATED APPLICATION

This application is a continuation of International Application No. PCT/CN2023/085679, filed on Mar. 31, 2023, which is hereby incorporated by reference in its entirety.

### TECHNICAL FIELD

The present disclosure relates to the technical field of image processing and recognition, in particular to a posture recognition system, a method and an electronic device.

### BACKGROUND

Traditional human-computer interaction generally employs touch interaction, while in the fields of VR/AR, naked-eye 3D display and the like, information of a user's postures, such as a gesture, is acquired by sensor devices (e.g. cameras), the postures are recognized through relevant recognition and classification algorithms, and different postures are imparted with different semantic information, thereby achieving different interaction functions. Most of the existing posture recognition algorithms run on a PC.

### SUMMARY

In a first aspect, embodiments of the present disclosure provide a posture recognition system, including: N depth cameras, N processing modules and a control module, wherein one of the processing modules is used to process a target image captured by one of the depth cameras, and N is an integer greater than 1;
the N depth cameras capture target images from different locations, and transmit the target images captured respectively to corresponding processing modules, wherein the target images contain depth information of a target object;
the N processing modules respectively determine a depth map of the target object based on the depth information contained in the target images received respectively, perform posture recognition on the target object in the target images in view of the depth map of the target object, to obtain N recognition results corresponding to the N depth cameras respectively, and send the N recognition results to the control module; and
the control module combines the N recognition results, and determines a combination result as a recognition result of the target image.

In an optional implementation, the processing modules are configured to:
determine a depth map of the target object based on depth information contained in consecutive M frames of target images; wherein any two frames of target images in the M frames of target images have different phase information corresponding to depth information contained therein; the M is determined based on shooting parameters of the depth camera, and the M is an integer greater than 0.

In an optional implementation, the processing modules are configured to:
input the depth map of the target object and the target images into a posture recognition model, and output a recognition result of the target object; wherein posture recognition models for posture recognition of different processing modules have different model parameters.

In an optional implementation, the processing modules are further configured to perform depth map computing and posture recognition computing respectively using different cores.

In an optional implementation, the control module includes a first sub-module and a second sub-module;
the first sub-module is configured to receive the N recognition results, and send the N recognition results to the second sub-module; and
the second sub-module is configured to combine the N recognition results to obtain a combination result.

In an optional implementation, the first sub-module is further configured to send any one or more of the following information to the processing modules:
a firmware code used to initialize the processing modules;
a notification message used to notify the processing modules to initialize a corresponding depth camera; and
a model parameter used by the processing modules to perform posture recognition on a target image received.

In an optional implementation, the first sub-module is further configured to:
send a pulse width modulation signal to a corresponding depth camera using the processing modules, and control different depth cameras to perform exposure shooting at intervals using pulse width modulation signals of different depth cameras; or,
adjust a register value of a corresponding depth camera using the processing modules, and control different depth cameras to perform exposure shooting at intervals using register values of different depth cameras.

In an optional implementation, the first sub-module is configured to:
determine a shooting interval duration of each of the N depth cameras, and send the same to a corresponding processing module, so that the processing module determines a register value of a corresponding depth camera based on the shooting interval duration received, and sends the same to the depth camera.

In an optional implementation, the second sub-module is further configured to:
receive N recognition results using a separate sub-thread, and combine the N recognition results to obtain a combination result.

In an optional implementation, the second sub-module is further configured to perform any one or more of the following:
displaying N recognition results;
displaying and storing the combination result; and
receiving a file containing model parameters input by a user, and sending the model parameters in the file to a corresponding processing module through the first sub-module.

In an optional implementation, the target object is a hand, the target image is a gesture image, and the recognition result is a gesture recognition result; the control module is further configured to:
obtain the gesture recognition result, and perform a corresponding gesture interaction operation using the gesture recognition result.

In the second aspect, embodiments of the present disclosure provide a posture recognition method, including:
capturing by N depth cameras, target images from different locations, and transmitting the target images captured respectively to corresponding processing modules, wherein the target images contain depth information of a target object; wherein one of the processing modules is used to process a target image captured by one of the depth cameras, and N is an integer greater than 1;
respectively determining by the N processing modules, a depth map of the target object based on the depth information contained in the target images received respectively, performing posture recognition on the target object in the target images in view of the depth map of the target object, to obtain N recognition results corresponding to the N depth cameras respectively, and sending the N recognition results to the control module; and
combining by the control module, the N recognition results, and determining a combination result as a recognition result of the target image.

In a third aspect, embodiments of the present disclosure also provide an electronic device, including a processor and a memory, wherein the memory is used to store a program executable by the processor, and the processor is used to read the program in the memory and perform the following steps:
capturing by N depth cameras, target images from different locations, and transmitting the target images captured respectively to corresponding processing modules, wherein the target images contain depth information of a target object; wherein one of the processing modules is used to process a target image captured by one of the depth cameras, and N is an integer greater than 1;
respectively determining by the N processing modules, a depth map of the target object based on the depth information contained in the target images received respectively, performing posture recognition on the target object in the target images in view of the depth map of the target object, to obtain N recognition results corresponding to the N depth cameras respectively, and sending the N recognition results to the control module; and
combining by the control module, the N recognition results, and determining a combination result as a recognition result of the target image.

In a fourth aspect, embodiments of the present disclosure also provide a non-transitory computer storage medium having stored thereon a computer program, which, when executed by a processor, is used to implement steps of the method according to the above second aspect.

### BRIEF DESCRIPTION OF FIGURES

In order to illustrate the technical solutions in the embodiments of the present disclosure more clearly, drawings required for description of the embodiments will be briefly described below. Apparently, the drawings in the following description are merely some embodiments of the present disclosure, and those of ordinary skill in the art can derive other drawings from these drawings without creative efforts.

FIG. 1 is a schematic diagram of a posture recognition system provided by an embodiment of the present disclosure;

FIG. 2 is a schematic diagram of a stream of images of a TOF camera provided by an embodiment of the present disclosure;

FIG. 3 is a schematic diagram of a framework of a recognition system provided by an embodiment of the present disclosure;

FIG. 4 is a schematic diagram of an internal framework of a DSP provided by an embodiment of the present disclosure;

FIG. 5 is a flow diagram of a gesture recognition of a DSP provided by an embodiment of the present disclosure;

FIG. 6 is a detailed flow diagram of the gesture recognition performed by the DSP provided by an embodiment of the present disclosure;

FIG. 7A are flow diagrams of implementation of a method for achieving interval exposure by adjusting a register provided by an embodiment of the present disclosure;

FIG. 7B are flow diagrams of implementation of a method for achieving interval exposure by adjusting a register provided by an embodiment of the present disclosure;

FIG. 8 is a flow diagram of control of an MCU provided by an embodiment of the present disclosure;

FIG. 9 is a flow diagram of execution of a PC provided by an embodiment of the present disclosure;

FIG. 10 is a flow diagram of implementation of a posture recognition method provided by an embodiment of the present disclosure;

FIG. 11 is a schematic diagram of an electronic device provided by an embodiment of the present disclosure.

### DETAILED DESCRIPTION

In order to make the purpose, technical solutions and advantages of the present disclosure clearer, the present disclosure will be described below in details in conjunction with the drawings of the present disclosure. Apparently, the described embodiments are some of the embodiments of the present disclosure, not all of them. Based on the embodiments of the present disclosure, all other embodiments obtained by those of ordinary skill in the art without creative efforts fall within the claimed scope of the present disclosure.

The term “and/or” in the embodiments of the present disclosure describes an association relationship between associated objects and represents that three relationships may exist. For example, A and/or B may represent the following three cases: only A exists, both A and B exist, and only B exists. The character “/” generally indicates an “or” relationship between the associated objects.

The application scenarios described in the embodiments of the disclosure are intended to illustrate the technical solutions in the embodiments of the present disclosure more clearly, and do not constitute a limitation on the technical solutions provided by the embodiments of the present disclosure. Those of ordinary skill in the art may appreciate that, with the appearance of new application scenarios, the technical solutions provided by the embodiments of the present disclosure are also applicable to similar problems. Here, in the description of the present disclosure, “multiple” means two or more unless otherwise specified.

Traditional human-computer interaction generally employs touch interaction, while in the fields of VR/AR, naked-eye 3D display and the like, information of a user's postures, such as a gesture, is acquired by sensor devices (e.g. cameras), the postures are recognized through relevant recognition and classification algorithms, and different postures are imparted with different semantic information, thereby achieving different interaction functions. Most of the existing posture recognition algorithms run on a PC. Since the communication between a camera and a PC cannot achieve a high frame rate, the overall latency of posture recognition algorithms is high. At the same time, posture recognition algorithms running on the PC are time-consuming as they require high computing power and consume a lot of system resources. The above latencies result in a high overall latency of posture recognition, and poor user experience.

Taking the gesture recognition as an example, most of the existing gesture recognition algorithms run on a PC. Due to the problem in the communication between a camera and a PC, a high frame rate cannot be achieved, and thus the overall latency is high. At the same time, gesture recognition algorithms running on the PC are time-consuming as they require high computing power and consume a lot of system resources. As a result of the above two kinds of latency, the overall latency of gesture recognition is high, and the user experience is poor. In addition, for a naked-hand interaction scene provided by a naked-eye 3D display screen, binocular cameras have low accuracy, and cannot achieve a good effect for large-size screens.

In order to reduce the latency of posture recognition such as gesture recognition, embodiments of the present disclosure provide a posture recognition system. Theposture recognition is performed for each depth camera through a separate processing module, and a posture recognition algorithm is implemented through the separate processing module, which can achieve an overall low latency of recognition, moreover, target images are captured from different locations by a plurality of depth cameras, which can obtain information of target images from different angles and improve the accuracy of recognition.

As shown in FIG. 1, the present embodiment provides a posture recognition system, including: N depth cameras 100, N processing modules 101 and a control module 102, wherein one of the processing modules is used to process a target image captured by one of the depth cameras, and N is an integer greater than 1;
the N depth cameras capture target images from different locations, and transmit the target images captured respectively to corresponding processing modules, wherein the target images contain depth information of a target object;
the N processing modules respectively determine a depth map of the target object based on the depth information contained in the target images received respectively, perform posture recognition on the target object in the target images in view of the depth map of the target object, to obtain N recognition results corresponding to the N depth cameras respectively, and send the N recognition results to the control module; and
the control module combines the N recognition results, and determines a combination result as a recognition result of the target images.

In some embodiments, the depth camera in the present embodiment includes, but is not limited to, a ToF (Time of flight) camera. According to the ToF camera in the present embodiment, a ToF sensor is used to emit an infrared light or laser light, the light generated therein will bounce off any object and return to the sensor, and the sensor can measure the distance between the object and the sensor based on a time difference between the emission of the light and the return of the light to the sensor after being reflected by the object. Taking gesture recognition as an example, the position of a user's gesture in a stereoscopic display space is acquired by the TOF camera, a gesture image is acquired by the camera to recognize a gesture action, and finally the position and the action of the user's gesture during the interaction are obtained, thereby achieving an interaction between a naked hand and a 3D content.

It should be noted that the depth camera in the present embodiment is not limited to a TOF camera, and any camera that can acquire depth information of a target object falls within the scope of the depth camera in the present disclosure.

Optionally, the target object in the present embodiment includes, but is not limited to, a human being, a robot, an animal or the like. The target object may also be an operable body part such as a finger, a palm, a hand, a joint, an arm, a leg, a foot, or the like, which will not be further limited in the present embodiment.

Optionally, the processing module in the present embodiment includes, but is not limited to, hardware devices with data processing capability such as a DSP, which will not be further limited in the present embodiment. In the implementation, one processing module is used to separately process a target image captured by one depth camera, and perform posture recognition on the target image to obtain a recognition result. Different processing modules are used to process target images captured by different depth cameras.

In some embodiments, the target object is a hand, the target image is a gesture image, and the recognition result is a gesture recognition result; the control module is further configured to:
obtain the gesture recognition result, and perform a corresponding gesture interaction operation using the gesture recognition result.

Optionally, the control module includes a first sub-module and a second sub-module. When the second sub-module includes a PC, a unity application of the PC is used to obtain a gesture recognition result from a shared memory that stores the gesture recognition result, and perform a gesture interaction operation.

In some embodiments, each of the processing modules is configured to:
determine a depth map of the target object based on depth information contained in a target image received; and
perform posture recognition on the target object in the target image in view of the depth map of the target object, to obtain a recognition result of the target object.

In the implementation, each frame of target image captured by the depth camera contains depth information, and a depth map of the target object can be calculated based on the depth information. The depth map in the present embodiment is used to represent a distance of the target object relative to the depth camera. After the depth map and the target image are obtained, posture recognition may be performed on the target object to obtain a distance from the target object to the depth camera and a posture of the target object, thereby achieving an interaction in a stereoscopic display space based on the distance and the posture.

In some embodiments, the processing module is configured to:
determine a depth map of the target object based on depth information contained in consecutive M frames of target images; wherein any two frames of target images in the M frames of target images have different phase information corresponding to depth information contained therein; the M is determined based on shooting parameters of the depth camera, and the M is an integer greater than 0.

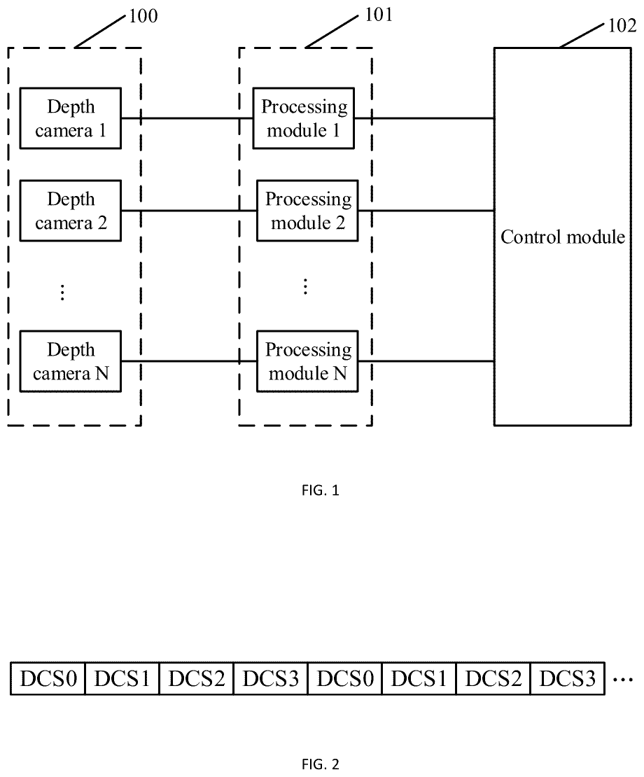

In the implementation, different depth information is represented by different phase information, which necessitates depth information of multiple frames of target images when the depth map is determined. Taking the case where the depth camera is a TOF camera as an example, as shown in FIG. 2, the present embodiment provides a schematic diagram of a stream of images of the TOF camera, wherein each DCS (Differential Correlation Sample) is one phase map, representing one frame of target image, and four phase maps are needed in order to calculate a depth map, that is, four frames of target images are needed in order to calculate the depth map of the target object.

In some embodiments, the processing module is configured to:
input the depth map of the target object and the target images into a posture recognition model, and output a recognition result of the target object; wherein posture recognition models for posture recognition of different processing modules have different model parameters.

In the implementation, the depth map and the target images are simultaneously input into the posture recognition module to obtain a recognition result of the target object. Optionally, the posture recognition model in the present embodiment includes, but is not limited to, a gesture recognition model or other models for posture recognition, which will not be further limited in the present embodiment. The posture recognition model in the present embodiment is disposed in a processing module. Each processing module uses its own posture recognition model to perform posture recognition on the target image received. Posture recognition models corresponding to different processing modules have different model parameters.

It should be noted that the posture recognition model and the posture recognition algorithm in the present embodiment belong to the same concept. Likewise, the gesture recognition model, the gesture recognition algorithm, and the recognition algorithm all belong to the same concept and represent the same algorithm.

In some embodiments, the processing module is further configured to perform depth map computing and posture recognition computing respectively using different cores.

In the implementation, taking the case where the processing module is a DSP as an example, the DSP includes core 0 and core 1, core 0 is used to calculate depth information to obtain a depth map, and core 1 is used to perform posture recognition to obtain a recognition result. In this way, it is possible to allocate computing resources, optimize the code flow, and improve the computing speed in a DSP with limited hardware resources.

In some embodiments, the control module in the present embodiment includes a first sub-module and a second sub-module;
the first sub-module is configured to receive the N recognition results, and send the N recognition results to the second sub-module; and
the second sub-module is configured to combine the N recognition results to obtain a combination result.

Optionally, the first sub-module in the present embodiment includes, but is not limited to, hardware devices with data processing control capability such as an MCU (Micro Control Unit). The second sub-module in the present embodiment includes, but is not limited to, host computers with operating systems such as a PC, a terminal, and a tablet computer.

As shown in FIG. 3, the present embodiment provides a schematic diagram of a framework of a recognition system, wherein the depth camera includes a TOF camera, the processing module includes a DSP, and the control module includes an MCU and a PC. Taking a 5-channel TOF camera as an example, each channel of TOF camera is controlled by a separate DSP, for processing a target image captured, the DSP is used to initialize the TOF camera and receive a target image sent by the TOF camera, a gesture recognition algorithm runs after the reception of the target image, recognition results obtained through the 5-channel DSP processing are all transmitted to the MCU after the completion of the algorithm, and are then sent by the MCU to the PC for combination processing.

In some embodiments, the first sub-module is further configured to send any one or more of the following information to the processing module:
a firmware code, used to initialize the processing module;
a notification message, used to notify the processing module to initialize a corresponding depth camera; and
a model parameter, used by the processing module to perform posture recognition on a target image received.

In the implementation, taking the case where the first sub-module is an MCU as an example, during the startup phase, the MCU initializes each DSP first, including sending a firmware code, a notification message and a model parameter, wherein the notification message is used to notify the DSP to initialize the corresponding TOF camera; the model parameter is used by the DSP to perform posture recognition with the model parameter. During the running process, a recognition result of the DSP is received and sent to the PC.

In some embodiments, when the processing module is a DSP, since the DSP per se does not have an ROM and cannot store a firmware code, the DSP cannot work independently, and an additional control module is needed to initialize the DSP and deliver the firmware code. In the present embodiment, an MCU can be used to control the DSP and initialize the DSP.

In some embodiments, a 5-channel TOF camera may be used, each TOF camera is disposed at a different position, and the gesture recognition models in the DSPs corresponding to different TOF cameras have different model parameters. Due to its limited space, MCU cannot store too many DSP firmware codes. Thus, in the present embodiment, the same DSP firmware code may be used. By optimizing the gesture recognition algorithm, the model parameters used in the gesture recognition algorithm are extracted, a call interface is added to the DSP, and different model parameters are delivered by the MCU to different TOF cameras.

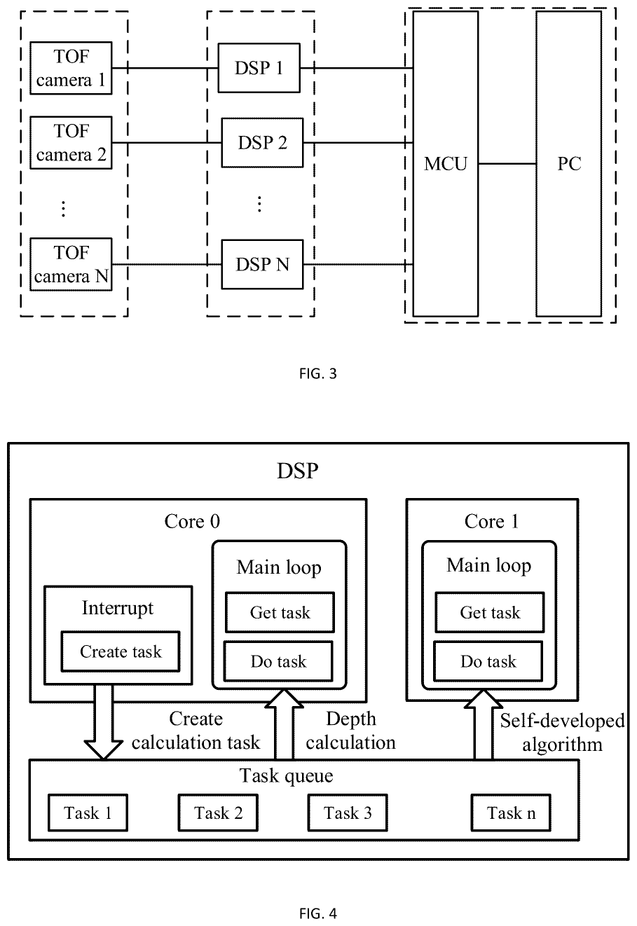

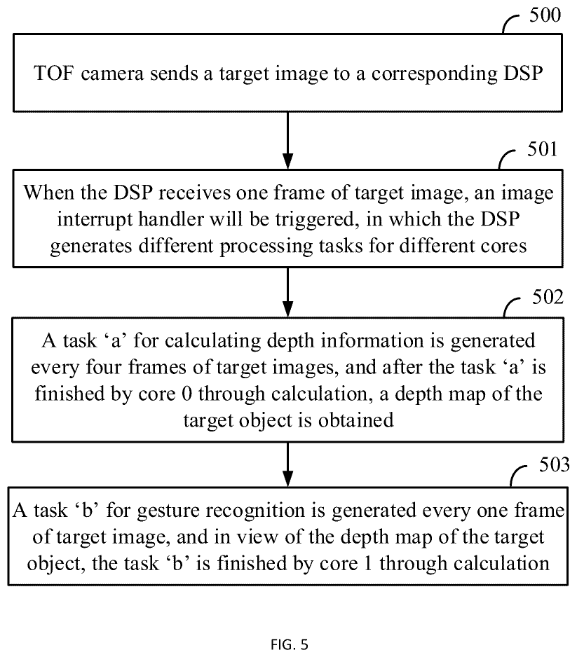

In some embodiments, as shown in FIG. 4, the present embodiment also provides a schematic diagram of an internal framework of a DSP, including two cores (Core 0 and Core 1). After the DSP receives the firmware code sent by the MCU, the initialization of each module in the DSP is implemented. After the initialization is finished, both cores (Core 0 and Core 1) in the DSP enter an infinite loop to obtain a task from a task queue, carry out the task if the task is obtained, and enter the next loop if no task is obtained.

The reception, by the DSP, of both an MCU message and image data (including target images) sent by the TOF camera is triggered by an interrupt. Simple calculations are performed in an interrupt handler, and complex calculation generation tasks are disposed in the task queue.

DSP computing power allocation: the core of DSP for processing an interrupt is core 0. Since the task of a gesture recognition algorithm is relatively heavy, the gesture recognition algorithm is executed separately in core 1, and an algorithm for depth information calculation is executed in core 0. In a DSP with limited hardware resources, by allocating computing resources and optimizing the code flow, it is ensured that, at 120 hz, the self-developed algorithm be completed within one frame time, that is, 8.3 ms.

As shown in FIG. 5, taking the case where the depth camera is a TOF camera, the processing module is a DSP, and the posture recognition is gesture recognition as an example, the present embodiment provides a DSP gesture recognition process. The specific implementation steps are as follows:

Step 500: The TOF camera sends a target image to a corresponding DSP,
in the implementation, the target image captured by the TOF camera is an IR image (an infrared spectrum image), and the IR image contains depth information.

Step 501: When the DSP receives one frame of target image, an image interrupt handler will be triggered, in which the DSP generates different processing tasks for different cores.

Step 502: A task ‘a’ for calculating depth information is generated every four frames of target images, and after the task ‘a’ is finished by core 0 through calculation, a depth map of the target object is obtained.

Step 503: A task ‘b’ for gesture recognition is generated every one frame of target image, and in view of the depth map of the target object, the task ‘b’ is finished by core 1 through calculation.

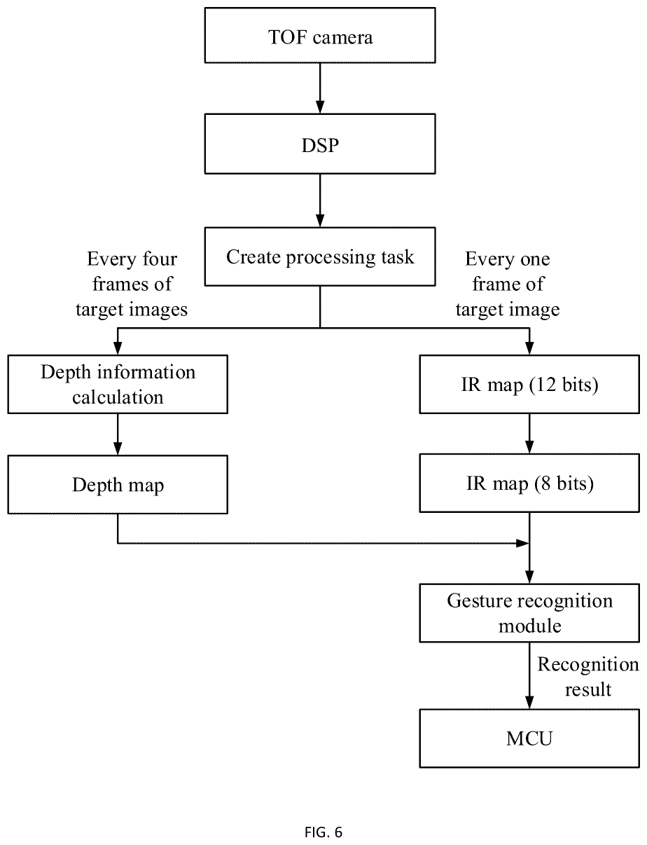

In the implementation, as shown in FIG. 6, the present embodiment further provides a detailed flow diagram of the gesture recognition performed by the DSP. Prior to the gesture recognition with core 1, the size of the target image may be converted to the size of a gesture recognition algorithm input, for example, a 12-bit target image may be converted to an 8-bit target image, then the converted target image is input together with the depth map to a gesture recognition model, a recognition result is output, and the recognition result is sent to an MCU through an SPI (Serial Peripheral Interface).

It should be noted that, since the depth calculation takes a long time of about 23 ms, when the converted target image is input together with the depth map to the gesture recognition model, the input of the depth map to the gesture recognition model is not always successful. The gesture recognition model can perform different recognition calculations, depending on whether or not the depth map of the target image is obtained.

In some embodiments, the first sub-module in the present embodiment is further configured to perform any of the following methods.

Method 1: sending a pulse width modulation signal to a corresponding depth camera using the processing module, and controlling different depth cameras to perform exposure shooting at intervals using pulse width modulation signals of different depth cameras.

Optionally, taking the case where the first sub-module is an MCU and the processing module is a DSP as an example, the MCU sends pulse width modulation signals to the DSPs, and the DSPs forward the same to the corresponding depth cameras respectively, thereby controlling the depth cameras to perform exposure at intervals.

Method 2: adjusting a register value of a corresponding depth camera using the processing module, and controlling different depth cameras to perform exposure shooting at intervals using register values of different depth cameras.

Optionally, taking the case where the first sub-module is an MCU and the processing module is a DSP as an example, the MCU calculates register values of the depth cameras to control different depth cameras to perform exposure at intervals, the MCU first sends the register values to the corresponding DSPs, and then the DSPs forward the same to the corresponding depth cameras respectively, thereby controlling the depth cameras to perform exposure at intervals, wherein the register value of the depth camera can control the shooting time and other information of the depth camera.

In the implementation, taking the case where the depth camera is a TOF camera as an example, since the TOF camera captures images by receiving an infrared light emitted by itself, for multiple TOF cameras, different TOF cameras cannot perform exposure shooting simultaneously, otherwise they will interfere with each other, so a synchronization scheme should be designed.

In the present embodiment, the following synchronization schemes are designed, which can solve the synchronization problem among multiple TOF cameras and avoid interference caused by exposure of different TOF cameras.

### Scheme 1. Hard Synchronization.

Optionally, a pulse width modulation signal is sent to a corresponding depth camera using the processing module, and different depth cameras are controlled to perform exposure shooting at intervals using pulse width modulation signals of different depth cameras.

Since each frame of target image of the TOF camera is a DCS phase map, here one phase map is expressed as a small frame, four phase maps are needed in order to calculate one depth map, and every four DCS phase maps are expressed as a large frame. In the implementation, an additional PWM (pulse width modulation) signal should be provided to the TOF camera. Every time the TOF camera receives a PWM signal, the TOF will output four phase maps, that is, output four frames of target images. In this way, the synchronization of every four frames of target images, i.e., the synchronization of a large frame, is controlled. For example, when the TOF camera is configured at 120 hz, the PWM signal is set at 30 hz.

This scheme is relatively stable, but has high requirements on the hardware resources of the MCU that controls the TOF cameras because each TOF camera requires a PWM signal.

### Scheme 2. Soft Synchronization.

Optionally, a register value of a corresponding depth camera is adjusted using the processing module, and different depth cameras are controlled to perform exposure shooting at intervals using register values of different depth cameras.

In some embodiments, the first sub-module is configured to:
determine a shooting interval duration of each of the N depth cameras, and send the same to a corresponding processing module, so that the processing module determines a register value of a corresponding depth camera based on the shooting interval duration received, and sends the same to the depth camera.

In the implementation, taking the case where the depth camera is a TOF camera and the processing module is a DSP as an example, the TOF camera can adjust the interval of large frames (every 4 frames of target images) in real time without interruption by adjusting its own register. For example, at 120 hz, the interval of large frames is 8.3 ms, if a delay of 1 ms relative to the current time is required, it is only necessary to change the interval to 9.3 ms, run one large frame, and then change the interval of large frames back to 8.3 ms, whereby a delay of 1 ms can be achieved. A delivery time point of the register can be selected by the following method.

For example, it is found through debugging that in this TOF camera, modifying the register will delay the validation by one large frame (consisting of four small frames). If the modification is made at the fourth small frame, the validation will be delayed by two large frames. In order to make the time controllable, in the present embodiment, it is optional to update the register of the TOF camera when the first small frame of target image, the second small frame of target image, or the third small frame of target image is received.

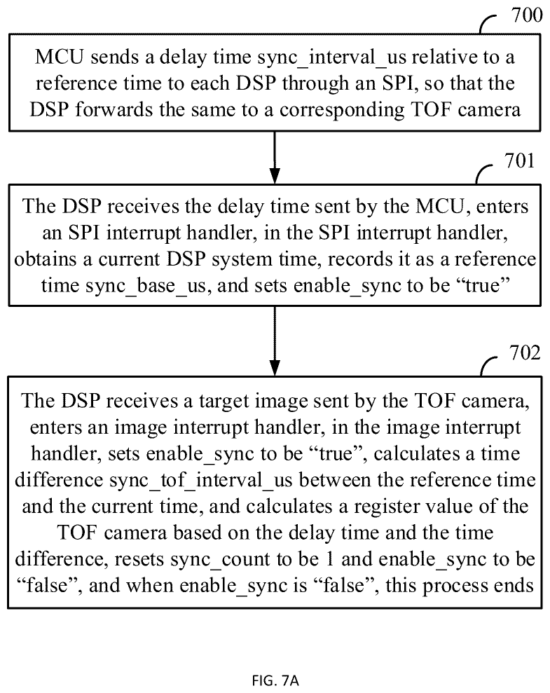

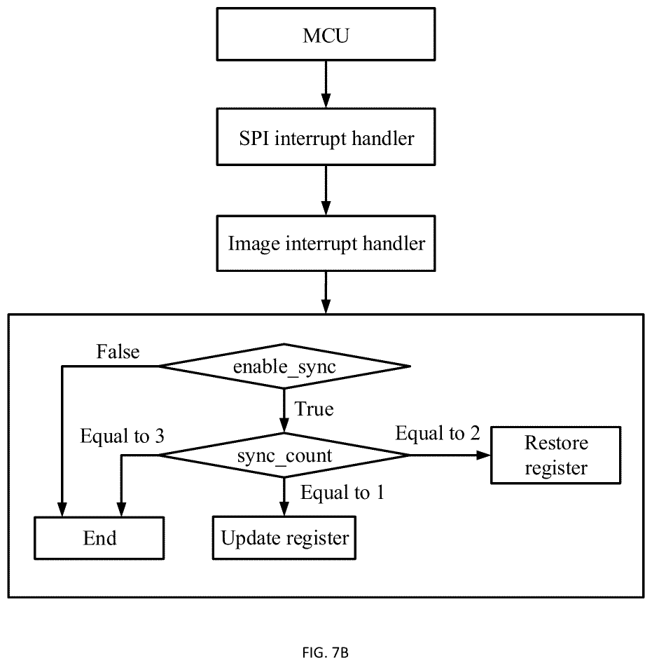

As shown in FIGS. 7A-7B, the present embodiment provides a method for achieving interval exposure by adjusting a register. Taking the case where the depth camera is a TOF camera, the processing module is a DSP, and the first sub-module as an MCU as an example, the specific implementation process of the method is as follows:

Step 700: The MCU sends a delay time sync_interval_us relative to a reference time to each DSP through an SPI, so that the DSP forwards the same to a corresponding TOF camera.

Step 701: The DSP receives the delay time sent by the MCU, enters an SPI interrupt handler, in the SPI interrupt handler, obtains a current DSP system time, records it as a reference time sync_base_us, and sets enable_sync to be “true”.

Step 702: The DSP receives a target image sent by the TOF camera, enters an image interrupt handler, in the image interrupt handler, sets enable_sync to be “true”, calculates a time difference sync_tof_interval_us between the reference time and the current time, and calculates a register value of the TOF camera based on the delay time and the time difference, resets sync_count to be 1 and enable_sync to be “false”, and when enable_sync is “false”, this process ends.

As shown in FIG. 7B, in the implementation, in the image interrupt handler, the sync_count variable can be controlled to set upon the reception of which small frame of target image will the register be updated. For example, the register value may be updated when the second small frame is received. If the current target image is the first small frame and sync_count is 1, then the register value is updated when the second small frame is received, and sync_count is increased by 1 to become 2. If the current target image is the first small frame and sync_count is 2, then register is restored to the configuration of 120 hz, sync_count is increased by 1 to become 3, and this process ends.

In the implementation, a soft synchronization method is used for multi-TOF camera synchronization, which can save MCU resources and reduce the requirements for MCU selection.

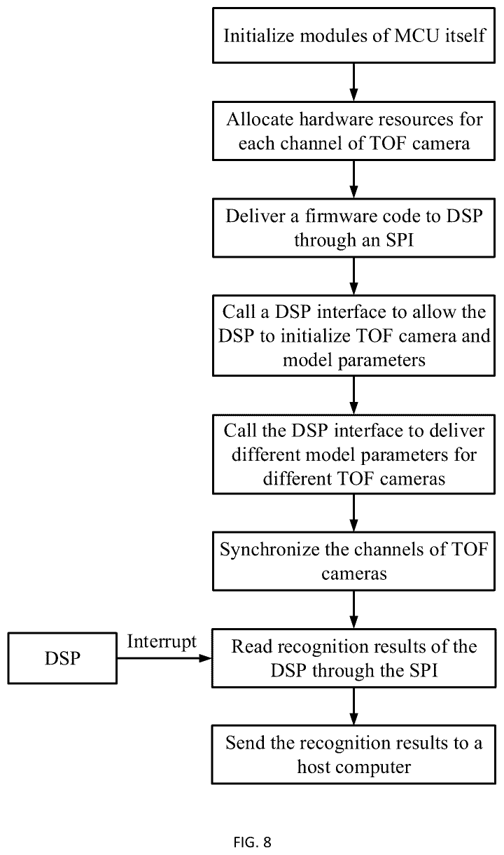

In some embodiments, as shown in FIG. 8, the present embodiment provides a control flow of an MCU, which is shown as follows.

In the process of controlling a TOF camera through a DSP, the MCU first initializes its own modules SPI, PWM, GPIO (General-purpose input/output, input and output pins) and the like. Then the MCU allocates hardware resources (such as a set of SPI and control signals) for each channel of TOF camera, and stores them in the same structure to make it easy to distinguish target images of different TOF cameras, as well as firmware codes, model parameters and other information of different DSPs. The MCU sends a notification message to the DSP to reset the TOF camera, delivers a firmware code to the DSP through an SPI, and calls a DSP interface to allow the DSP to initialize TOF camera and model parameters. The MCU calls the DSP interface to deliver different model parameters for different TOF cameras. Finally, the MCU synchronizes the channels of TOF cameras (using either hard synchronization or soft synchronization), then enters normal operation, reads recognition results of the DSP through the SPI, and then sends them to a host computer (PC) through a USB (serial port protocol).

In some embodiments, the second sub-module is further configured to:
receive N recognition results using a separate sub-thread, and combine the N recognition results to obtain a combination result.

In the implementation, the second sub-module may be a host computer, a PC, or the like. An overall low latency is achieved by putting the gesture recognition algorithm in the DSP. The overall hardware latency is about 12 ms from when a gesture is captured to when the host computer PC obtains a gesture recognition result. The latency can be less than 5 ms with the gesture recognition algorithm.

In some embodiments, the second sub-module is further configured to perform any one or more of the following:
a) displaying N recognition results;
   in the implementation, taking a PC as an example, the PC first initializes the main interface, initializes the serial port, and separately initializes the data processing as a sub-thread, so as to receive recognition results of a N-channel TOF camera, and combine them through a combination algorithm to obtain a combination result. In the main interface, all the recognition results of the N-channel TOF camera can be displayed through options, which are mainly used for debugging.
b) displaying and storing the combination result;
   in the implementation, the combination results can be displayed in the main interface and stored in a shared memory so as to be easily obtained by other applications. For example, a unity application may easily obtain a gesture recognition result from the shared memory for performing various interaction operations.
c) receiving a file containing model parameters input by a user, and sending the model parameters in the file to a corresponding processing module through the first sub-module.
   in the implementation, in the main interface, a file containing model parameters may be imported and sent to the MCU, and then sent to the DSP through the MCU. It is used for debugging the recognition effect of the posture recognition model online without repeatedly flashing the firmware for the MCU.

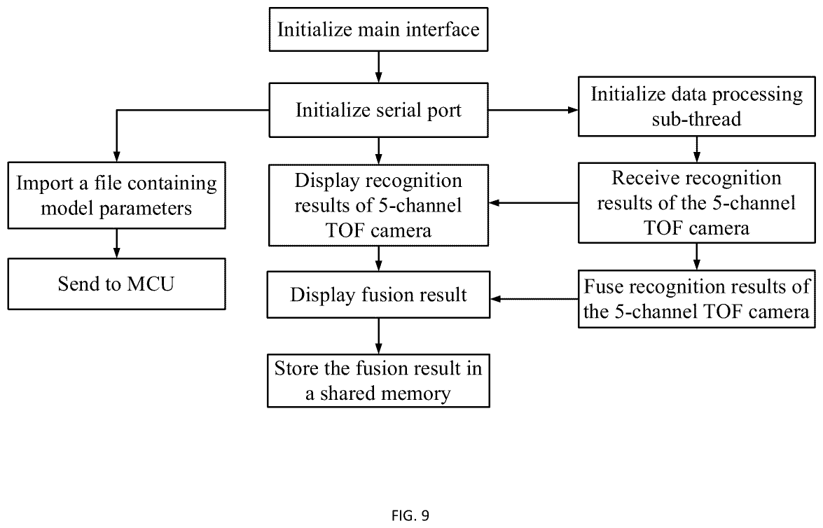

As shown in FIG. 9, the present embodiment further provides a flow of execution of a PC. Taking the case where the depth camera is a TOF camera and N is 5 as an example, the main interface is initialized, the serial port is initialized, the data processing sub-thread may also be initialized, so as to receive recognition results of the 5-channel TOF camera, and combine them through a combination algorithm to obtain a combination result, the recognition results of the 5-channel TOF camera are displayed, the combination result is displayed, and the combination result is stored in a shared memory, a file containing model parameters may also be imported, and sent to the MCU, and then sent to the DSP through the MCU.

In the posture recognition system provided by the present embodiment, an N-channel depth camera is used, each channel of depth camera is controlled separately by a processing module (e.g., a DSP). A posture recognition algorithm (e.g., a gesture recognition algorithm) runs in the processing module, and then a result of the posture recognition algorithm is sent to a second sub-module (e.g., a PC) through a first sub-module (e.g., an MCU). The PC aggregates N channels of recognition results and combines them into a combination result, which is stored in a shared memory. The Unity application obtains the combination result from the shared memory, thus completing the entire interaction process. In the first aspect, a multi-channel depth camera is used to capture the posture of a target object, making the posture recognition more accurate. In the second aspect, the posture recognition algorithm is put in the DSP, thereby achieving an overall low latency, moreover, in a DSP with limited hardware resources, computing resources are allocated reasonably, and the code flow is optimized, thereby further reducing the computing latency. In the third aspect, to solve the synchronization problem among multiple channels of depth cameras and avoid interference generated by exposure between depth cameras, a soft synchronization method is employed, which can save MCU resources and reduce the requirements for MCU selection.

Embodiment 2. Based on the same inventive concept, the embodiments of the present disclosure further provide a posture recognition method. Since the principle of the method for solving the problem is similar to the principle of the system for solving the problem, for the implementation of the method, reference may be made to the implementation of the system, which will not be repeated herein.

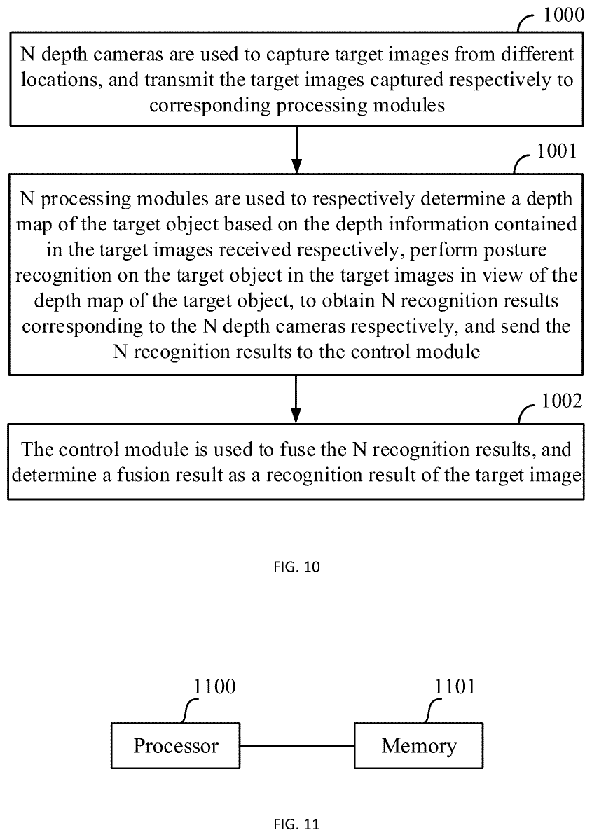

As shown in FIG. 10, the present embodiment provides an implementation flow of a posture recognition method, which is described as follows:
Step 1000: N depth cameras are used to capture target images from different locations, and transmit the target images captured respectively to corresponding processing modules;
wherein the target images contain depth information of a target object; one of the processing modules is used to process a target image captured by one of the depth cameras, and N is an integer greater than 1;
Step 1001: N processing modules are used to respectively determine a depth map of the target object based on the depth information contained in the target images received respectively, perform posture recognition on the target object in the target images in view of the depth map of the target object, to obtain N recognition results corresponding to the N depth cameras respectively, and send the N recognition results to the control module;
Step 1002: the control module is used to combine the N recognition results, and determine a combination result as a recognition result of the target image.

In an optional implementation, each processing module determines a depth map of the target object by the following method of:
determining a depth map of the target object based on depth information contained in consecutive M frames of target images; wherein any two frames of target images in the M frames of target images have different phase information corresponding to depth information contained therein; wherein the M is determined based on shooting parameters of the depth camera, and the M is an integer greater than 0.

In an optional implementation, the performing posture recognition on the target object in the target images in view of the depth map of the target object includes:
inputting the depth map of the target object and the target images into a posture recognition model, and outputting a recognition result of the target object; wherein posture recognition models for posture recognition of different processing modules have different model parameters.

An optional implementation further includes:
performing depth map computing and posture recognition computing respectively using different cores.

In an optional implementation, the control module includes a first sub-module and a second sub-module;
the first sub-module is used to receive the N recognition results, and send the N recognition results to the second sub-module; and
the second sub-module is used to combine the N recognition results to obtain a combination result.

An optional implementation further includes sending, using the first sub-module, any one or more of the following information to the processing module:
a firmware code, used to initialize the processing module;
a notification message, used to notify the processing module to initialize a corresponding depth camera; and
a model parameter, used by the processing module to perform posture recognition on a target image received.

An optional implementation further includes that:
the first sub-module sends a pulse width modulation signal to a corresponding depth camera using the processing module, and controls different depth cameras to perform exposure shooting at intervals using pulse width modulation signals of different depth cameras; or,
the first sub-module adjusts a register value of a corresponding depth camera using the processing module, and controls different depth cameras to perform exposure shooting at intervals using register values of different depth cameras.

In an optional implementation, the first sub-module determines a shooting interval duration of each of the N depth cameras, and sends the same to a corresponding processing module, so that the processing module determines a register value of a corresponding depth camera based on the shooting interval duration received, and sends the same to the depth camera.

In an optional implementation, the second sub-module receives N recognition results using a separate sub-thread, and combines the N recognition results to obtain a combination result.

In an optional implementation, the second sub-module is further used to perform any one or more of the following:
displaying N recognition results;
displaying and storing the combination result; and
receiving a file containing model parameters input by a user, and sending the model parameters in the file to a corresponding processing module through the first sub-module.

In an optional implementation, the target object is a hand, the target image is a gesture image, and the recognition result is a gesture recognition result; wherein:

the gesture recognition result is obtained, and a corresponding gesture interaction operation is performed using the gesture recognition result.

Embodiment 3. Based on the same inventive concept, the embodiments of the present disclosure further provide an electronic device. Since the principle of the electronic device for solving the problem is similar to the principle of the system for solving the problem, for the implementation of the electronic device, reference may be made to the implementation of the system, which will not be repeated herein.

As shown in FIG. 11, the electronic device comprises a processor 1100 and a memory 1101, the memory 1101 is used to store a program executable by the processor 1100, and the processor 1100 is used to read the program in the memory 1101 and perform the following steps:
N depth cameras are used to capture target images from different locations, and transmit the target images captured respectively to corresponding processing modules, wherein the target images contain depth information of a target object; one of the processing modules is used to process a target image captured by one of the depth cameras, and N is an integer greater than 1;
N processing modules are used to respectively determine a depth map of the target object based on the depth information contained in the target images received respectively, perform posture recognition on the target object in the target images in view of the depth map of the target object, to obtain N recognition results corresponding to the N depth cameras respectively, and send the N recognition results to the control module; and
a control module is used to combine the N recognition results, and determine a combination result as a recognition result of the target image.

In an optional implementation, the processer 1100 is configured to use each processing module to determine a depth map of the target object by the following method of:
determining a depth map of the target object based on depth information contained in consecutive M frames of target images; wherein any two frames of target images in the M frames of target images have different phase information corresponding to depth information contained therein; the M is determined based on shooting parameters of the depth camera, and the M is an integer greater than 0.

In an optional implementation, the processer 1100 is configured to:
input the depth map of the target object and the target images into a posture recognition model, and output a recognition result of the target object; wherein posture recognition models for posture recognition of different processing modules have different model parameters.

In an optional implementation, the processer 1100 is further configured to:
perform depth map computing and posture recognition computing respectively using different cores.

In an optional implementation, the control module includes a first sub-module and a second sub-module;
the first sub-module is used to receive the N recognition results, and send the N recognition results to the second sub-module; and
the second sub-module is used to combine the N recognition results to obtain a combination result.

In an optional implementation, the processer 1100 is further configured to use the first sub-module to send any one or more of the following information to the processing module:
a firmware code, used to initialize the processing module;
a notification message, used to notify the processing module to initialize a corresponding depth camera; and
a model parameter, used by the processing module to perform posture recognition on a target image received.

In an optional implementation, the processer 1100 is further configured such that:
the first sub-module sends a pulse width modulation signal to a corresponding depth camera using the processing module, and controls different depth cameras to perform exposure shooting at intervals using pulse width modulation signals of different depth cameras; or,
the first sub-module adjusts a register value of a corresponding depth camera using the processing module, and controls different depth cameras to perform exposure shooting at intervals using register values of different depth cameras.

In an optional implementation, the processer 1100 is configured to use the first sub-module to determine a shooting interval duration of each of the N depth cameras, and send the same to a corresponding processing module, so that the processing module determines a register value of a corresponding depth camera based on the shooting interval duration received, and sends the same to the depth camera.

In an optional implementation, the second sub-module receives N recognition results using a separate sub-thread, and combines the N recognition results to obtain a combination result.

In an optional implementation, the processer 1100 is further configured to use the second sub-module to perform any one or more of the following:
displaying N recognition results;
displaying and storing the combination result; and
receiving a file containing model parameters input by a user, and sending the model parameters in the file to a corresponding processing module through the first sub-module.

In an optional implementation, the target object is a hand, the target image is a gesture image, and the recognition result is a gesture recognition result; the processor 1100 is further configured to:
obtain the gesture recognition result, and perform a corresponding gesture interaction operation using the gesture recognition result.

Based on the same inventive concept, embodiments of the present disclosure provide a non-transitory computer storage medium including a computer program code, which, when running on a computer, causes the computer to implement any one of the posture recognition methods as described above. Since the principle of the computer storage medium for solving the problem is similar to the principle of the posture recognition method for solving the problem, for the implementation of the computer storage medium, reference may be made to the implementation of the method, which will not be repeated herein.

In the specific implementation process, the computer storage medium may include: various storage media that can store program codes, such as a universal serial bus flash drive (USB), a mobile hard disk, a read-only memory (ROM), a random access memory (RAM), a magnetic disk or an optical disk.

Based on the same inventive concept, embodiments of the present disclosure provide a computer program product including a computer program code, which, when running on a computer, causes the computer to implement any one of the posture recognition methods as described above. Since the principle of the computer program product for solving the problem is similar to the principle of the posture recognition method for solving the problem, for the implementation of the computer program product, reference may be made to the implementation of the method, which will not be repeated herein.

The computer program product may use one or any combination of a plurality of readable media. The readable medium may be a readable signal medium or a readable storage medium. The readable storage medium may include, but is not limited to, an electrical, magnetic, optical, electromagnetic, infrared or semiconductor system, apparatus or device or any combination of the foregoing. More specific examples (a non-exhaustive list) of the readable storage medium would include the following: an electrical connection having one or more wires, a portable disk, a hard disk, a random access memory (RAM), a read-only memory (ROM), an erasable programmable read-only memory (EPROM or a flash memory), an optical fiber, a portable compact disc read-only memory (CD-ROM), an optical storage device, a magnetic storage device, or any suitable combination of the foregoing.

Those skilled in the art should understand that the embodiments of the present disclosure may be provided as a method, a system, or a computer program product. Therefore, the present disclosure can use a form of hardware only embodiments, software only embodiments, or embodiments with a combination of software and hardware. In addition, the present disclosure can use a form of a computer program product implemented on one or more computer-usable storage media (including but not limited to a magnetic disk memory, an optical memory, and the like) that include computer-usable program code.

The present disclosure is described with reference to the flow diagrams and/or block diagrams of the method, the device (system), and the computer program product based on the embodiments of the present disclosure. It should be understood that computer program instructions can be used to implement each procedure and/or each block in the flow diagrams and/or the block diagrams and a combination of a procedure and/or a block in the flow diagrams and/or the block diagrams. These computer program instructions can be provided for a general-purpose computer, a dedicated computer, an embedded processor, or a processor of another programmable data processing device to generate a machine, so that the instructions are executed by the computer or the processor of another programmable data processing device to generate an apparatus for implementing a specified function in one or more procedures in the flow diagrams and/or in one or more blocks in the block diagrams.

These computer program instructions may also be stored in a computer-readable memory that can instruct the computer or another programmable data processing device to work in a particular way, so that the instructions stored in the computer-readable memory generate an artifact that includes an instruction apparatus. The instruction apparatus implements a specified function in one or more procedures in the flow diagrams and/or in one or more blocks in the block diagrams.

These computer program instructions may also be loaded to a computer or another programmable data processing device, so that a series of operations and steps are performed on the computer or another programmable device to generate computer-implemented processing. Therefore, the instructions executed on the computer or another programmable device provide steps for implementing a specified function in one or more procedures in the flow diagrams and/or in one or more blocks in the block diagrams.

Apparently, those skilled in the art can make various modifications and variations to the present disclosure without departing from the spirit and scope of the present disclosure. In this way, if the modifications and variations of the present disclosure fall within the scope of the claims of the present disclosure and equivalent technologies, the present disclosure also intends to include these modifications and variations.

What is claimed is:

1. A posture recognition system, comprising: N depth cameras, N processing modules and a control module, wherein one of the processing modules is configured to process a target image captured by one of the depth cameras, and N is an integer greater than 1;
the N depth cameras capture target images from different locations, and transmit the target images captured respectively to corresponding processing modules, wherein the target images comprises depth information of a target object;
the N processing modules respectively determine a depth map of the target object based on the depth information comprised in the target images received respectively, perform a posture recognition on the target object in the target images in view of the depth map of the target object, to obtain N recognition results corresponding to the N depth cameras respectively, and send the N recognition results to the control module; and
the control module combines the N recognition results, and determines a combination result as a recognition result of the target image.

2. The system according to claim 1, wherein the processing modules are configured to:
determine the depth map of the target object based on depth information comprised in consecutive M frames of target images; wherein depth information comprised in any two frames of target images in the M frames of target images correspond to different phase information; the M is determined based on shooting parameters of the depth cameras, and the M is an integer greater than 0.

3. The system according to claim 1, wherein the processing modules are configured to:
input the depth map of the target object and the target images into a posture recognition model, and output a recognition result of the target object; wherein posture recognition models for posture recognition of different processing modules comprise different model parameters.

4. The system according to claim 1, wherein the processing modules are further configured to perform depth map computing and posture recognition computing respectively using different cores.

5. The system according to claim 1, wherein the control module comprises a first sub-module and a second sub-module;
the first sub-module is configured to receive the N recognition results, and send the N recognition results to the second sub-module; and
the second sub-module is configured to combine the N recognition results to obtain a combination result.

6. The system according to claim 5, wherein the first sub-module is further configured to send any one or more of following information to the processing modules:
a firmware code used to initialize the processing modules;
a notification message used to notify the processing modules to initialize a corresponding depth camera; and
a model parameter used by the processing modules to perform the posture recognition on a target image received.

7. The system according to claim 5, wherein the first sub-module is further configured to:
send a pulse width modulation signal to a corresponding depth camera using the processing modules, and control different depth cameras to perform exposure shooting at intervals using pulse width modulation signals of different depth cameras; or,
adjust a register value of a corresponding depth camera using the processing modules, and control different depth cameras to perform exposure shooting at intervals using register values of different depth cameras.

8. The system according to claim 7, wherein the first sub-module is configured to:
determine a shooting interval duration of each of N depth cameras, and send the shooting interval duration to a corresponding processing module, so that the corresponding processing module determines a register value of a corresponding depth camera based on the shooting interval duration received, and sends the register value to the corresponding depth camera.

9. The system according to claim 5, wherein the second sub-module is further configured to:
receive N recognition results using a separate sub-thread, and combine the N recognition results to obtain the combination result.

10. The system according to claim 5, wherein the second sub-module is further configured to perform any one or more of following:
displaying N recognition results;
displaying and storing the combination result; and
receiving a file comprising model parameters input by a user, and sending the model parameters in the file to a corresponding processing module through the first sub-module.

11. The system according to claim 1, wherein the target object is a hand, the target image is a gesture image, and the recognition result is a gesture recognition result; the control module is further configured to:
obtain the gesture recognition result, and perform a corresponding gesture interaction operation using the gesture recognition result.

12. A posture recognition method, comprising:
capturing, by N depth cameras, target images from different locations, and transmitting the target images captured respectively to corresponding processing modules, wherein the target images comprise depth information of a target object; each of the processing modules is configured to process a target image captured by one of the depth cameras, and N is an integer greater than 1;
determining, by N processing modules, a depth map of the target object based on the depth information comprised in the target images received respectively, performing a posture recognition on the target object in the target images in view of the depth map of the target object, to obtain N recognition results corresponding to the N depth cameras respectively, and sending the N recognition results to a control module; and
combining, by the control module, the N recognition results, and determining a combination result as a recognition result of the target image.

13. An electronic device, comprising a processor and a memory, wherein the memory is configured to store a program executable by the processor, and the processor is configured to read the program in the memory and perform followings:
capturing target images from different locations, and transmitting the target images captured respectively to corresponding processing modules, wherein the target images comprise depth information of a target object; each of the processing modules is configured to process a target image captured by one of the depth cameras, and N is an integer greater than 1;
determining a depth map of the target object based on the depth information comprised in the target images received respectively, performing a posture recognition on the target object in the target images in view of the depth map of the target object, to obtain N recognition results corresponding to the N depth cameras respectively, and sending the N recognition results to a control module; and
combining the N recognition results, and determining a combination result as a recognition result of the target image.

14. The electronic device according to claim 13, wherein the processor is configured to read the program in the memory and perform following:
determining the depth map of the target object based on depth information comprised in consecutive M frames of target images; wherein depth information comprised in any two frames of target images in the M frames of target images correspond to different phase information; the M is determined based on shooting parameters of the depth cameras, and the M is an integer greater than 0.

15. The electronic device according to claim 13, wherein the processor is configured to read the program in the memory and perform following:
inputting the depth map of the target object and the target images into a posture recognition model, and outputting a recognition result of the target object; wherein posture recognition models for posture recognition of different processing modules comprise different model parameters.

16. The electronic device according to claim 13, wherein the processor is configured to read the program in the memory and perform following:
performing depth map computing and posture recognition computing respectively using different cores.

17. The electronic device according to claim 13, wherein the processor is configured to read the program in the memory and perform following:
sending a pulse width modulation signal to a corresponding depth camera using the processing modules, and controlling different depth cameras to perform exposure shooting at intervals using pulse width modulation signals of different depth cameras; or,
adjusting a register value of a corresponding depth camera using the processing modules, and controlling different depth cameras to perform exposure shooting at intervals using register values of different depth cameras.

18. The electronic device according to claim 17, wherein the processor is configured to read the program in the memory and perform following:
determining a shooting interval duration of each of N depth cameras, and sending the shooting interval duration to a corresponding processing module, so that the corresponding processing module determines a register value of a corresponding depth camera based on the shooting interval duration received, and sends the register value to the corresponding depth camera.

19. The electronic device according to claim 13, wherein the processor is configured to read the program in the memory and perform following:
receiving N recognition results using a separate sub-thread, and combining the N recognition results to obtain the combination result.

20. A non-transitory computer storage medium storing a computer program, when the computer program is executed by a processor, the processor is caused to implement steps of the method according to claim 12.
